(19) United States
(12) Patent Application Publication
(10) Pub. No.: US 2012/0040266 A1
(43) Pub. Date: Feb. 16, 2012

(54) FUEL CELL MODULE

(76) Inventor: Jeong-Doo YI, Yongin-si (KR)

(21) Appl. No.: 13/075,095

(22) Filed: Mar. 29, 2011

(30) Foreign Application Priority Data
Aug. 10, 2010 (KR) 10-2010-0077031

(51) Int. Cl. H01M 8/24

(52) U.S. Cl. 429/455; 429/452

(57) ABSTRACT

A fuel cell module includes a first unit cell including a first electrode, an electrolyte layer and a second electrode; and a second unit cell assembly connected to the first unit cell and including at least a second unit cell. In the fuel cell module, the respective fuel reaction areas of the unit cells are different from one another.

### CROSS-REFERENCE TO RELATED APPLICATIONS

This application claims priority to and the benefit of Korean Patent Application No. 10-2010-0077031, filed on Aug. 10, 2010, in the Korean Intellectual Property Office, the entire content of which is incorporated herein by reference.

### BACKGROUND

1. Field

Embodiments of the present invention relate to a connection structure of fuel cells, and more particularly, to a fuel cell module for reducing degradation of power.

2. Description of Related Art

Fuel cells are cells that convert chemical energy generated by oxidation into electric energy Fuel cells are an eco-friendly technology utilized to generate electric energy from materials such as oxygen and hydrogen, which are abundant in the environment. In a fuel cell, an electrochemical reaction is performed as an inverse reaction of the electrolysis of water by respectively supplying oxygen and fuel gas to a cathode and an anode, thereby producing electricity, heat and water. Therefore, the fuel cell produces electricity at high efficiency without causing pollution.

Among these fuel cells, solid oxide fuel cells are widely used because the position of electrolytes are easily controlled, there is no concern about the exhaustion of fuel, and the lifetime of materials is relatively long.

### SUMMARY OF THE INVENTION

In one embodiment, there is provided a fuel cell module in which, as the respective lengths of sequentially connected unit cells are sequentially increased along a length direction of the module, the fuel reaction areas of each subsequent unit cell is also sequentially increased, so that a sufficient or greater fuel reaction effect can be obtained, even though the density of the fuel is decreased while the fuel passes through the unit cells.

According to an aspect of an embodiment of the present invention, there is provided a fuel cell module including: a first unit cell including a first electrode, an electrolyte layer and a second electrode; and a second unit cell assembly connected to the first unit cell and including at least a second unit cell, wherein respective fuel reaction areas of the unit cells of the fuel cell module are different from one another.

The unit cells of the fuel cell module may be connected such that the respective fuel reaction areas of the unit cells increase along a length of the fuel cell module.

The unit cells of the fuel cell module may be connected substantially along a direction in which fuel is supplied to the fuel cell module.

The unit cells of the fuel cell module may be connected such that respective lengths of the unit cells increase along the direction in which fuel is supplied, and wherein a rate of increase between the lengths of adjacent unit cells is less than or equal to 1.5.

The respective lengths of the unit cells of the fuel cell module may sequentially increase along the direction in which fuel is supplied.

The first unit cell may be provided with a fuel inlet through which fuel is supplied to the fuel cell module. One of the at least a second unit cell of the second unit cell assembly may be provided with a fuel outlet through which fuel is discharged from the fuel cell module.

The length of one of the unit cells of the fuel cell module may vary by less than or equal to 50% with respect to the length of an adjacent unit cell.

As described above, according to embodiments of the present invention, unit cells are connected so that the fuel reaction areas of the unit cells are sequentially increased, thereby preventing or reducing occurrence of the entire power of the fuel cell module from being lowered.

Also, a maximum or greater power can be obtained by providing an optimized or efficient length increasing rate or ratio of unit cells and an optimized or efficient length of the entire fuel cell module, so that the consumption rate of fuel can be increased.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic view showing a connection structure of general unit cells;

FIG. 2 is a schematic view showing a structure of unit cells and a connection structure between the unit cells according to an embodiment of the present invention;

FIG. 3 is a cross-sectional view showing a structure of a unit cell and a coupling structure with a connection cap according to an embodiment of the present invention; and

FIG. 4 is a graph showing a correlation between a length of a unit cell and a power of the unit cell according to an embodiment of the present invention.

### DETAILED DESCRIPTION

In the following detailed description, only certain exemplary embodiments of the present invention have been shown and described, by way of illustration. As those skilled in the art will recognize, the described embodiments may be modified in various different ways without departing from the spirit or scope of the present invention. Accordingly, the drawings and description are to be regarded as illustrative in nature and not restrictive. In addition, when an element is referred to as being “on” another element, it can be directly on the other element, or be indirectly on the other element, with one or more intervening elements interposed therebetween. Also, when an element is referred to as being “connected to” another element, it can be directly connected to the other element, or be indirectly connected to the other element, with one or more intervening elements interposed therebetween. Hereinafter, like reference numerals refer to like elements. In the drawings, thicknesses or sizes of layers are exaggerated for clarity and are not necessarily drawn to scale.

Solid oxide fuel cells are generally classified as either a cylinder type or a plate type according to the shape of the unit cells. A cylinder-type solid oxide fuel cell is basically formed in a structure in which an electrolyte layer and a cathode are sequentially stacked on an outer circumferential surface of a cylindrical anode. Generally, in a fuel cell, an amount of electricity generated by each unit cell individually is relatively small and insufficient, and therefore, electricity may be substantially simultaneously generated in several unit cells that are connected to one another. In this instance, the electrical connection of the unit cells may be either a serial connection or a parallel connection. Meanwhile, embodiments of the present invention do not focus on the electrical connections between unit cells based on the current collection method described above, but instead focus on connections between unit cells corresponding to a supply of fuel. Embodiments of the present invention provide a structure in which unit cells are connected to one another substantially in a row in a direction in which fuel is supplied thereto. In embodiments of the present invention, a connection assembly of unit cells will be defined as a fuel cell module.

That is, a fuel cell module used in embodiments of the present invention refers to a connection or coupling assembly of unit cells connected to one another substantially in a direction in which fuel is supplied thereto.

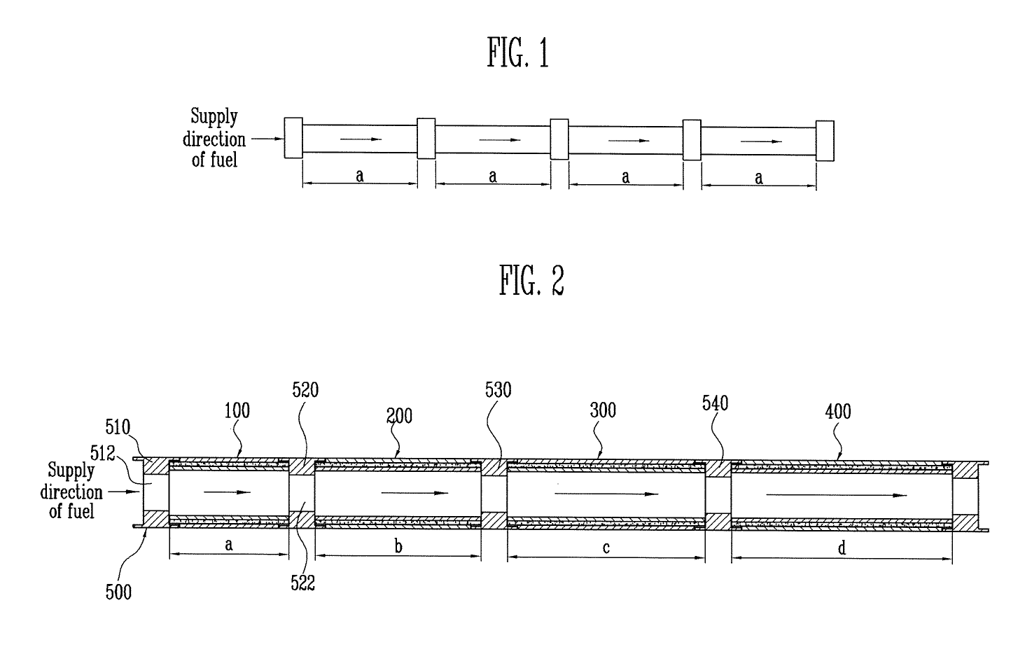

FIG. 1 shows an arrangement in which unit cells are connected to one another in a direction in which fuel is supplied thereto in a general fuel cell module. In the fuel cell module shown in FIG. 1, ends of unit cells having a same length “a” are connected to one another in a row so that fuel is supplied in one direction through the unit cells. In this instance, the fuel supply structure of each of the unit cells is formed in a manner that, after fuel is supplied through a fuel inlet of one unit cell positioned at one end of the fuel cell module, it passes through the corresponding unit cell, and is sequentially supplied to adjacent unit cells. However, since the fuel is consumed while sequentially passing through the unit cells in the fuel supply structure, the density of the supplied fuel may decrease as the fuel sequentially passes through each of the unit cells. Further, since a time or duration during which the fuel is consumed in each of the unit cells may be too short or insufficient, the reaction efficiency of the entire module may be reduced.

FIG. 2 shows a fuel cell module according to an embodiment of the present invention. FIG. 3 is a sectional view showing a structure of a unit cell and a coupling structure of the unit cell with connection caps according to an embodiment of the present invention.

As shown in FIG. 2, the fuel cell module according to this embodiment is formed into a structure in which a plurality of unit cells are connected to one another substantially in a row. The lengths of the unit cells are different from one another and may be sequentially increased. However, an upper limit may be put on the rate or amount of increase or variation in length in view of, for example, efficiency and power. In a case where the lengths of the unit cells are sequentially increased as described above, the fuel reaction areas of the fuel cells are also sequentially increased.

For reference, in this embodiment, the structure in which four unit cells are connected to one another will be described as an example. However, the number of unit cells may be varied depending on a desired amount of power.

As shown in FIGS. 2 and 3, a fuel cell module having unit cells connected therein is provided with a first unit cell 100 including a fuel inlet unit. The fuel inlet unit (not shown) may have a fuel inlet formed in the first unit cell 100, and fuel containing hydrogen may initially be supplied to the first unit cell 100. As shown in FIG. 3, each of the unit cells is formed by sequentially stacking a first electrode 110, an electrolyte layer 120 and a second electrode 130.

The first electrode 110 is an anode to which hydrogen gas is supplied, and may be formed in the shape of a hollow circular tube with opened ends. The first electrode 110 may be made of zirconia (NiO+YSZ) ceramic to which nickel is added.

The electrolyte layer 120 positioned on the outer circumferential surface of the first electrode 110 serves as a path for hydrogen ions in the supplied fuel. The electrolyte layer 120 may also be formed in a hollow circular tube to surround an outer circumferential surface of the first electrode 110. The electrolyte layer 120 may also be made of a ceramic material such as zirconia, so that the mobility of the hydrogen ions is maximized or increased.

The second electrode 130 corresponding to a cathode may surround an outer circumferential surface of the electrolyte layer 120. In this instance, the length of the second electrode 130 may be formed shorter than that of the electrolyte layer 120, so as not to cover certain sections of the ends of the electrolyte layer 120.

A connection cap 500 is connected to each end of the electrolyte layer 120, approximate where the second electrode 130 is not formed. The connection cap 500 serves as a fuel supply path with a fuel inlet (not shown), as well as a connection with a second unit cell assembly which will be described later. The connection caps 500 may include a first connection cap 510, a second connection cap 520, a third connection cap 530 and a fourth connection cap 540, etc.

First, the first connection cap 510 serves as a path along which fuel supplied from the fuel inlet initially flows into the first unit cell 100. The first connection cap 510 may be formed in a shape of a circular stopper, and one end portion of the electrolyte layer 120 may be inserted into the first connection cap 510. A fuel inlet path 512 that serves as an inlet passage for fuel gas is formed at or approximate a center of the first connection cap 510 to communicate with the interior of the first electrode 110. The shape of the first connection cap 510 is not limited to a circular shape, but may be, for example, a prismatic shape, according to the shape of the unit cells.

The second connection cap 520 serves as both a connection with the second unit cell assembly and a path along which the fuel that passes through the first unit cell 100 can be discharged. The second connection cap 520 has substantially the same structure as the first connection cap 510. That is, a fuel discharge path 522 is formed at or approximate the center of the second connection cap 520, and the other end portion of the electrolyte layer 120 is inserted into one side of the second connection cap 520.

In this embodiment, the fuel cells are connected to one another along a direction in which the fuel is supplied thereto. The first unit cell 100 is basically formed to have a same length and size as a general unit cell, and length “a” of the first unit cell 100 may be, for example, about 10 to 20 cm, taking into consideration, for example, the number of unit cells connected to the first unit cell 100 and the entire length of the serial connection structure.

A second unit cell assembly having one or more unit cells is connected to the second connection cap 520 coupled to the first unit cell 100. The second unit cell assembly includes a second unit cell 200. The second unit cell 200 is basically formed in substantially a same structure as the first unit cell 100. That is, the second unit cell 200 is formed to have a multiple-tube structure in which a first electrode 110, an electrolyte layer 120 and a second electrode 130 are sequentially stacked.

One end portion of the second unit cell 200 imay be inserted into the other side of the second connection cap 520, and the first and second unit cells 100 and 200 may therefore be connected to each other through the second connection cap 520, where the interiors of the first and second unit cells 100 and 200 communicate with each other. In this instance, the diameter of the second unit cell 200 is substantially the same as that of the first unit cell 100, but a length “b” of the second unit cell 200 is longer than that of the first unit cell 100. The length “b” of the second unit cell 200 may have a length increasing rate or ratio of, for example, less than or equal to 1.5 times the length of the first unit cell 100. The length increasing rate will be further described below. As the length “b” of the second unit cell 200 is longer than the length “a” of the first unit cell 100, the internal area of the second unit cell 200, i.e., the fuel reaction area of the second unit cell 200, is greater than that of the first unit cell 100, and therefore, a reaction duration of the second unit cell 200 with the fuel can be increased.

A third connection cap 530 with substantially a same structure as the second connection cap 520 may be coupled to the other end portion of the second unit cell 200. A third unit cell 300 with substantially a same structure as the first and second unit cells 100 and 200 may be inserted into the other side of the third connection cap 530. In this instance, the length “c” of the third unit cell 300 is formed longer than that of the second unit cell 200. Like the length increasing rate between the first and second unit cells 100 and 200, the length “c” of the third unit cell 300 may have a length increasing rate of, for example, less than or equal to 1.5 times the length “b” of the second unit cell 200. Thus, the internal area of the third unit cell 300 is greater than that of the second unit cell 200, and therefore the fuel reaction area of the third unit cell 300 is also greater than that of the second unit cell 200.

A fourth connection cap 540 with substantially a same structure as the third connection cap 530 may be coupled to the other end portion of the third unit cell 300, and one end portion of a fourth unit cell 400 with substantially a same structure as the first, second and third unit cells 100, 200 and 300 may be inserted into the other side of the fourth connection cap 540. In this instance, the length “d” of the fourth unit cell 400 may have a length increasing rate of, for example, less than or equal to 1.5 times the length “c” of the third unit cell 300, such that the fourth unit cell 400 is connected to the third unit cell 300, and a fuel reaction area of the fourth unit cell 400 is greater than that of the third unit cell 300.

As described above, the first unit cell 100 and the second, third and fourth unit cells 200, 300 and 400 are connected in a direction in which the fuel is supplied thereto through the second, third and fourth connection caps 520, 530 and 540. In this embodiment, the second, third and fourth unit cells 200, 300 and 400 are referred to together as a second unit cell assembly. This is because, in some embodiments, the second unit cell assembly may include only a second unit cell 200, and it is sufficient to say that a number of unit cells in the second unit cell assembly is one or more.

Meanwhile, the fuel cell module in this embodiment has a structure in which the first to fourth unit cells 100 to 400 are connected to one another and the lengths of the first to fourth unit cells 100 to 400 are sequentially increased (a<b<c<d). Accordingly, the respective fuel reaction areas of the unit cells 100, 200, 300 and 400 are also sequentially increased. As described above, additional unit cells may be additionally connected after the fourth unit cell 400 in series according to the amount of desired power. In this instance, the lengths of the added unit cells may be sequentially increased. It can be understood that any additional unit cells added to the fourth unit cell 400 may also be considered part of the second unit cell assembly.

Hereinafter, the operation and effect of this embodiment will be described.

As shown in FIG. 2, the first unit cell 100 and the second unit cell assembly including the second, third and fourth unit cells 200, 300 and 400 are connected in a length direction of the unit cells while the lengths of the unit cells are sequentially increased, and therefore, the respective fuel reaction areas of the unit cells are also sequentially increased. A fuel outlet is provided to the unit cell connected at an end in the second unit cell assembly opposite the first unit cell 100. Thus, fuel containing oxygen sequentially passes through the unit cells, and the fuel reaction areas of the unit cells are sequentially increased. Accordingly, as the fuel sequentially passes through the unit cells, decrease in power generation from cell to cell can be minimized or reduced.

That is, the fuel containing oxygen is supplied to the interior of the first unit cell 100 through the first connection cap 510 to be reacted and consumed at a typical reaction rate. Then, the rest of the fuel (e.g., unreacted fuel) is supplied to the second unit cell 200 through the second connection cap 520 to further react while passing through the second unit cell 200. As a result, a portion of the unreacted fuel is consumed or reacted. In this instance, since the volume of fuel discharged from a fuel supply unit is constant, the density of the fuel supplied to the second unit cell 200 may be lower after passing through the first unit cell 100. However, since the length “b” of the second unit cell 200 is f longer than the length “a” of the first unit cell 100 as described above, a volume of fuel that comes in contact with the interior of the second unit cell 200, i.e., a reaction volume of the fuel, is increased, and the time during which the fuel passes through the second unit cell 200, i.e., a reaction time or duration of the fuel, is extended. Thus, the consumption rate of the fuel in the second unit cell 200 can be maintained at a proper or more consistent level as compared to that of the first unit cell 100. The density of the fuel supplied to the interior of the third unit cell 300 through the third connection cap 530 via the second unit cell 200 may be even lower after passing through the second unit cell 200. However, similarly as discussed above, since the length “c” of the third unit cell 300 is longer than the length “b” of the second unit cell 200, a reaction area and reaction duration or time of the third unit cell 300 with the fuel are greater than those of the second unit cell 200. Thus, the consumption rate of the fuel, i.e., the amount of power generated by the third unit cell 300 can also be more sufficiently maintained. Similarly, since the length “d” of the fourth unit cell 400 is longer than the length “c” of the third unit cell 300, a reaction area and reaction duration or time of the fourth unit cell 400 with the fuel are further increased. Thus, the reaction rate in the fourth unit cell 400 can also be more sufficiently maintained. In addition, since the reaction areas and times of any additional unit cells sequentially connected to the fourth unit cell 400 would further be sequentially increased, power efficiency can be sufficiently obtained throughout an entire serial connection assembly of unit cells.

However, in a case where the length of each of the unit cells is unconditionally increased, the consumption rate of the fuel in each of the unit cells may exceed a proper or optimal consumption rate, and hence, power may be lowered. Further, power may be lowered by a wire for current collection between the unit cells. Therefore, an entire length of the fuel cell modules may not exceed, for example, 50 cm.

For example, when an entire length of the fuel cell module is twice as long as that of another fuel cell module, its power rate may be increased by about 50%. However, the amount of power does not infinitely increase with increases in the length of each of the unit cells. Thus, when the length increasing rate of the unit cells is less than, for example, 50% with respect to the length of another unit cell, a maximum or most desirable or efficient power efficiency can be obtained.

That is, in this embodiment, the lengths of the unit cells are sequentially increased. Here, where the length “a” of the first unit cell 100 is limited to 10 to 20 cm, the length increasing rate of the second, third and fourth unit cells may not exceed 1.5 times a previous unit cell, and the sum of the lengths of the unit cells may not exceed 50 cm.

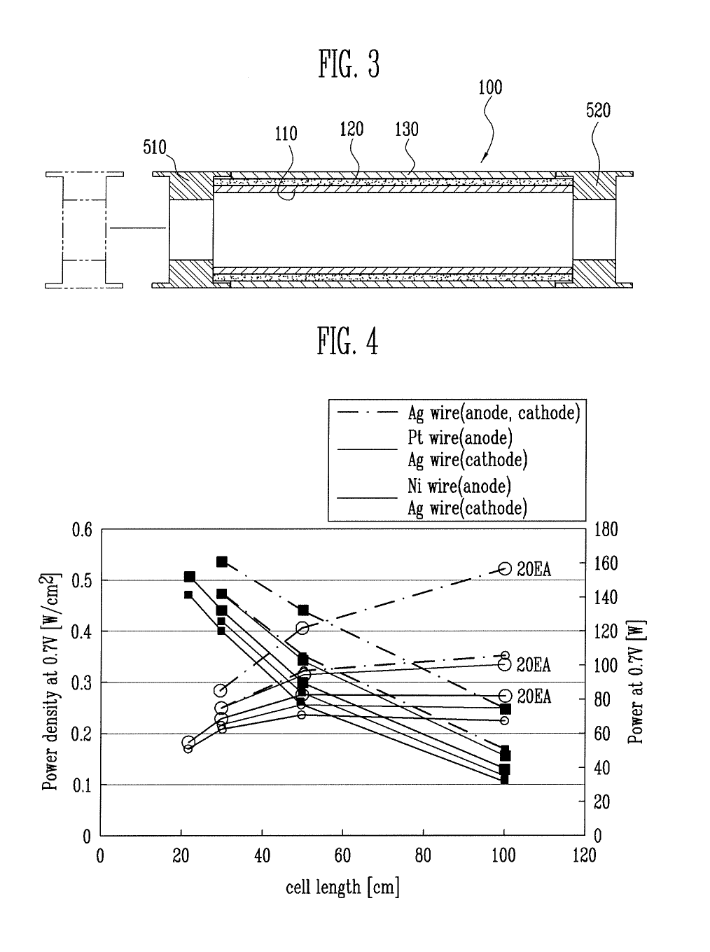

FIG. 4 is a graph showing changes in power density according to lengths of unit cells in a fuel cell connection structure. As can be seen in this figure, if the length of the unit cell is increased, the consumption rate of fuel is decreased, and therefore, power is lowered. Further, power may be lowered from wiring for current collection for the unit cell.

Referring to FIG. 4, three cases are shown, i.e., a case where Ni and Ag wires are used as current collectors, a case where Pt and Ag wires are used as current collectors, and a case where an Ag wire is used for both an anode and a cathode. As can be seen in FIG. 4, where the Ag wire is used for both the anode and the cathode, power is highest. However, when Ag wire is used for both the anode and cathode, the increase in power is insignificant or reduced when a length of the entire unit cell is more than 50 cm. Furthermore, in a case where the length increasing rate or ratio of the unit cells is 2, power is increased at a rate of about less than 50%. Similarly, in a case where the Ni and Ag wires and the Pt and Ag wires are used as current collectors, power efficiency reacts similarly when the length of the entire unit cell is more than 50 cm. Thus, it is insignificant or effectiveness is reduced when the length of the entire unit cell is greater than 50 cm, and it may therefore be preferable that the length of the entire unit cell is kept shorter than 50 cm.

As can be seen in FIG. 4, in a case where the length of the entire unit cell is changed from about 25 to 50 cm, the power density is increased from about 0.2 to 0.3 W/cm², and the power is increased from about 60 to 90 W. Conversely, the increase in power becomes more insignificant when the length of the entire cell is greater than 50 cm. Therefore, it can be seen that when the length of the entire unit cell is increased by two times (e.g., doubled), the power is increased in the range of about 50%. However, based on FIG. 4, it is insignificant or may not be desirable for the length of the unit cell to be longer than 50 cm, and it may be preferable that the lengths of the unit cells are sequentially increased in the fuel supply direction, where a length increasing rate of one unit cell does not exceed 1.5 times with respect to a length of the previous unit cell. Accordingly, the length increasing rate of one unit cell is increased less than 1.5 with respect to the length of the previous unit cell, so that the consumption rate of fuel can be increased in an injection direction of the fuel.

As described above, unit cells are connected substantially in the fuel supply direction, and the lengths of the unit cells are sequentially increased. Therefore, the reaction areas and reaction durations or times of the unit cells are also sequentially increased. Accordingly, although the specific gravity of fuel is decreased while the fuel passes through the unit cells, the amount of power in each of the unit cells can be sufficiently or more stably obtained or maintained from unit cell to unit cell.

While the present invention has been described in connection with certain exemplary embodiments, it is to be understood that the invention is not limited to the disclosed embodiments, but is instead intended to cover various modifications and equivalent arrangements included within the spirit and scope of the appended claims, and equivalents thereof.

What is claimed is:

1. A fuel cell module comprising:
a first unit cell comprising a first electrode, an electrolyte layer and a second electrode; and
a second unit cell assembly connected to the first unit cell and comprising at least a second unit cell,
wherein respective fuel reaction areas of the unit cells of the fuel cell module are different from one another.

2. The fuel cell module according to claim 1, wherein the unit cells of the fuel cell module are connected such that the respective fuel reaction areas of the unit cells increase along a length of the fuel cell module.

3. The fuel cell module according to claim 1, wherein the unit cells of the fuel cell module are connected substantially along a direction in which fuel is supplied to the fuel cell module.

4. The fuel cell module according to claim 3, wherein the unit cells of the fuel cell module are connected such that respective lengths of the unit cells increase along the direction in which fuel is supplied, and wherein a rate of increase between the lengths of adjacent unit cells is less than or equal to 1.5.

5. The fuel cell module according to claim 4, wherein the respective lengths of the unit cells of the fuel cell module sequentially increase along the direction in which fuel is supplied.

6. The fuel cell module according to claim 5, wherein the first unit cell is provided with a fuel inlet through which fuel is supplied to the fuel cell module.

7. The fuel cell module according to claim 6, wherein one of the at least a second unit cell of the second unit cell assembly is provided with a fuel outlet through which fuel is discharged from the fuel cell module.

8. The fuel cell module according to claim 4, wherein the length of the first unit cell is about 10 to 20 cm.

9. The fuel cell module according to claim 8, wherein a sum of the respective lengths of the unit cells of the fuel cell module is about less than or equal to 50 cm.

10. The fuel cell module according to claim 1, wherein respective lengths of the unit cells of the fuel cell module are different from one another.

11. The fuel cell module according to claim 10, wherein the length of one of the unit cells of the fuel cell module varies by less than or equal to 50% with respect to the length of an adjacent unit cell.

12. The fuel cell module according to claim 11, wherein the first electrode is an anode and the second electrode is a cathode.

13. The fuel cell module according to claim 11, further comprising connection caps between the unit cells.

14. The fuel cell module according to claim 13, wherein a length of each of the connection caps is substantially the same.

15. The fuel cell module according to claim 13, further comprising at least one of Ni wires or Ag wires formed as current collectors on the first and second electrodes.

16. The fuel cell module according to claim 13, further comprising at least one of Pt wires or Ag wires formed as current collectors on the first and second electrodes.
